(19) United States
(12) Patent Application Publication
(10) Pub. No.: US 2019/0232286 A1
(43) Pub. Date: Aug. 1, 2019

(54) Assay Device and Method for Assessing Blood Cells

(71) Applicant: GENTIAN AS, Moss (NO)

(72) Inventor: Erling Sundrehagen, Grebbestad (SE)

(21) Appl. No.: 16/311,557

(22) PCT Filed: Jul. 24, 2017
(86) PCT No.: PCT/EP2017/068645

§ 371 Date: Dec. 19, 2018

(30) Foreign Application Priority Data
Jul. 25, 2016 (EP) 16180938.9

(51) Int. Cl. B01L 3/00

(52) U.S. Cl. CPC B01L 3/502753; B01L 2300/0803; B01L 2300/0861; B01L 3/5635

(57) ABSTRACT

The present invention relates to an assay device and its use in medical analytics, in particular a method for assessing blood or blood cells.

The present invention relates to an assay device and its use in medicine, in particular as analytical tool in medical analytics or diagnostics and to a method for assessing blood or its constituents, in particular blood cells.

### BACKGROUND OF THE INVENTION

The analysis of specific analytes, like receptor molecules on the surface of blood cells, is crucial for the diagnosis of a variety of diseases and allows health professionals choosing the most promising treatment strategy. Vertical flow assays are widely applied in the field of diagnostics and analysis of biomedical samples, e.g., samples of whole blood or samples derived from whole blood. They are particularly used in an immunoassay format, but not limited thereto. One essential requirement for the development of vertical flow assays for day-to-day use in medical environments is a high degree of usability such that the scope of potential users is not limited to specifically trained medical doctors, but also includes their assistants and even their patients.

One important step in performing a vertical flow assay with blood samples is the removal of cellular blood components from the sample, which might otherwise falsify the test results. This is commonly achieved by pretreatment steps, which require additional equipment for pretreatment of the sample to be analyzed which would result in additional time required for performing the assay and which also will increase the costs per assay

### SUMMARY OF THE INVENTION

Therefore, the problem to be solved by the present invention is to provide a medical testing device and a method for assessing blood cells that allow a highly efficient and fast analytical testing.

This object is achieved by the provision of an assay device and an analytical method according to the claims. The assay device according to the invention may be operated in an especially simple and secure manner. The assay may be designed such that it is not only usable by health care professionals, but also helpers and patients. The integration into other processes such as a medical examination is facilitated.

### DETAILED DESCRIPTION OF THE INVENTION

### a) General Definitions

Unless otherwise stated the term “upper” refers to the side of the device at which the sample to be analyzed (as for example an optionally pre-treated blood sample) is added and enters the device.

Unless otherwise stated the term “inner” refers to those parts of the device which are not or substantially not in direct contact with the surrounding environment.

The “first configuration” may also be designated as “sample addition configuration”.

The “second configuration” may also be designated as “reagent addition configuration” or “read-out configuration” or “reading configuration”.

The “first opening” may also be designated as “sample addition opening” or “sample feed opening”. In said opening the optionally pre-treated blood sample is added and washed into the first filter layer, so that cell agglomerates optionally formed in said sample are retained by said filter.

The “second opening” may also be designated as “reagent addition opening”, “reading opening” or “read-out opening”. A detectable signal formed upon addition of a reagent specific for the analyte (as for example cells to be assessed) may be detected and read out from said opening.

An “absorbent layer” comprises a suitable natural or synthetic material which has the ability to physically absorb the liquid phase (including constituents dissolved or suspended therein) of the sample to be analyzed, the washing liquids added during the assay method as well as the liquid phase of the liquid reagent medium (solution or dispersion of required reagents in a liquid phase) added into the device as well as unreacted constituents of said reagent medium. The size (volume) of said absorbent layer depends on the total volume of liquid to be absorbed and the absorption capacity of the absorbent material and should preferably exceed the volume of the liquid to be absorbed.

A “vertical flow assay” or “vertical flow immune assay” according to the present invention is characterized by the vertical flow of a fluid through the assay device. The assay device comprises a multiplicity (i.e. at least two or more particularly three) layers either identical or, preferably, of different functionality stacked one upon the other. Such functional layers may be selected from grids, filter membranes and adsorbent layers.

“Present on the surface” of a cell means that said molecule (like cell surface marker) is either bound to the cell surface or is integral part of the cell membrane and extends beyond the cell membrane into the extra-cellular space and optionally also into the intra-cellular space (i.e. the cytoplasm).

“Specific for” in the context of a reaction comprising the binding of a binding agent (like an antibody) to a target (like in particular an antigen, like CD4 or CD8), defines the ability of the binding agent to specifically recognize and bind said particular intended target while showing no cross-reactivity with a different target (in particular antigen) which might also be present in the sample to be analyzed.

“Antibody” relates to any class of “immunoglobulin molecule” (like IgA, D, E G, M, W, Y) and any isotype, including without limitation IgA1, IgA2, IgG1, IgG2, IgG3 and IgG4. Said term refers, in particular, to a functional (i.e. having the ability to bind to an antigen) monoclonal or polyclonal antibody (Ab) or fragment antibody (fAb) capable of binding to a particular antigen. Said Abs and fAbs are selected from chemically or enzymatically produced molecules or may be produced non-recombinantly or recombinantly by prokaryotic or eukaryotic microorganism or cell lines, or may be produced by higher organisms, like mammalian, preferably non-human mammalian species, or non-mammalian species, preferably avian species, or plants. Said fAbs may be selected from the group consisting of: monovalent antibodies (consisting of one heavy and one light chain), Fab, F(ab′)₂ (or Fab₂), Fab₃, scFv, bis-scFv, minibody, diabody, triabody, tetrabody, tandab; and single antibody domains, like V_{H} and V_{L} domains, and fragments thereof; wherein polyvalent fragments thereof may bind to different or, preferably, the same antigenic determinant of the same antigen, like in particular CD4 or CD8.

The term “labelled antibody” as used herein, refers to an antibody molecule as defined above with a label incorporated that provides for the identification of the antibody (preferably after binding to the respective antigen. Particularly, the label is a “detectable marker”, e.g., incorporation of a radio-labelled amino acid or attachment to a polypeptide of biotinyl moieties that can be detected by marked avidin (e.g., streptavidin containing a fluorescent marker or enzymatic activity that can be detected by optical or colorimetric methods). Examples of labels for antibodies include, but are not limited to, the following:
radioisotopes or radionuclides (e.g., ³G, ¹⁴C, ³⁵S, ⁹⁰Y, ⁹⁹Tc, ¹¹¹In, ¹³¹I, ¹⁷⁷Lu, ¹⁶⁶Ho, or ¹⁵³Sm);
fluorescent labels (e.g., FITC, rhodamine, lanthanide phosphors),
enzymatic labels (e.g., horseradish peroxidase, luciferase, alkaline phosphatase);
chemiluminescent markers;
biotinyl groups;
predetermined polypeptide epitopes recognized by a secondary reporter (e.g., leucine zipper pair sequences, binding sites for secondary antibodies, metal binding domains, epitope tags); and
polymer particles (e.g. colored nanoparticles)
metal particles (like gold nanoparticles)
magnetic agents, such as gadolinium chelates and
oligonucleotides.

A “whole blood” sample as used in the assay method according to the invention is a sample derived from a mammal, in particular a human being. Any “Whole blood sample” may be used. Said samples may be used “as is”, i.e. without any pre-treatment, directly as taken from the blood donor, or may be pre-treated prior to the assay. Thus, for example whole blood in this context means a non-modified sample of whole blood or a sample where an anticoagulant has been added to the sample or a sample derived from whole blood, e.g. by adding a buffer or another liquid. Examples of suitable samples are native, untreated whole blood and pre-treated whole-blood blood, like EDTA blood, citrate blood, heparin blood. The originally obtained samples may be further modified by dilution. Fractionation of whole blood to remove constituents which might disturb the assay is not required. Dilution may be performed by mixing the original sample with a suitable sample liquid, like a suitable buffer, in order to adjust the concentration of the constituents, as for example of the analyte. The sample may also be pre-treated by hemolysis, as for example selective hemolysis of erythrocytes. Such modified samples exemplify samples “derived from” the original whole blood sample collected or isolated from the body of the mammal.

An “analyte” to be assayed according to the invention is a cell marker, like cell surface marker, in particular CD4 or CD8.

“CD4” (cluster of differentiation 4) is a glycoprotein found on the surface of immune cells such as T helper cells, monocytes, macrophages, and dendritic cells. It was discovered in the late 1970s and was originally known as leu-3 and T4 before being named CD4 in 1984.

“CD4+ T helper cells” are white blood cells that are an essential part of the human immune system. They are often referred to as CD4 cells, T-helper cells or T4 cells. They are called helper cells because one of their main roles is to send signals to other types of immune cells, including CD8 killer cells, which then destroy the infectious particle. If CD4 cells become depleted, for example in untreated HIV infection, or following immune suppression prior to a transplant, the body is left vulnerable to a wide range of infections that it would otherwise have been able to fight.

“CD8” (cluster of differentiation 8) is a transmembrane glycoprotein that serves as a co-receptor for the T cell receptor (TCR). Like the TCR, CD8 binds to a major histocompatibility complex (MHC) molecule, but is specific for the class I MHC protein. There are two isoforms of the protein, alpha and beta, each encoded by a different gene. The CD8 co-receptor is predominantly expressed on the surface of cytotoxic T cells, but can also be found on natural killer cells, cortical thymocytes, and dendritic cells.

“CD14” (cluster of differentiation 14), also known as CD14, is a human gene. The protein encoded by this gene is a component of the innate immune system. CD14 exists in two forms, one anchored to the membrane by a glycosylphosphatidylinositol tail (mCD14), the other a soluble form (sCD14). Soluble CD14 either appears after shedding of mCD14 (48 kDa) or is directly secreted from intracellular vesicles (56 kDa). CD14 is expressed mainly by macrophages and (at 10-times lesser extent) by neutrophils. It is also expressed by dendritic cells and monocytes.

A “Blood cell of interest” (BCol) as referred to herein belongs to a class or population or, more particular, to a sub-class or sub-population of cells typically present in a whole blood sample to be assessed according to the invention. Such (sub)-classes or (sub)-populations are distinguishable from each other in the test environment (whole blood sample) on the basis of a particular cell surface marker or a pattern of such markers which may be analyzed by means of corresponding antibody molecules specific for said marker or pattern of markers.

A “sub-class”, “sub-set” or “sub-population” of cells refers to a group of blood cells which are functionally and antigenically related. Examples thereof are (CD4+) T-Helper cells or CD8+ cytotoxic T cells.

Examples of a “class” or “population” of blood cells ate T-lymphoctes and B-lymphocytes.

“Distinguishable” in this context means that the particular marker is either “specific” for said particular BCol, i.e. is not detectable in any other body cell, or is “subclass-specific” and therefore not detectable in another cell population of the blood sample to be analyzed, or is “non-specific” as it is detectable on other blood cells which are present in the whole blood sample as well, however, which are either present in a very low proportion, and does not negatively affect or falsify the assay result, or are removed from the sample before the assessment of the BCol is performed.

“Specific for” a class, population, sub-class or sub-population of cells in the context of the present invention, therefore, has to be understood broadly if not otherwise stated.

“Assessing” or “assessment” is intended to include both quantitative and qualitative determination in the sense of obtaining an absolute value for the amount or concentration of the analyte, present in the sample, and also obtaining an index, ratio, percentage, visual or other value indicative of the level of analyte in the sample. Assessment may be direct or indirect and the chemical species actually detected need not of course be the analyte itself but may for example be a derivative thereof.

### b) Particular Preferred Embodiments

The present invention refers to the following embodiments:

A first general embodiment refers to the following device:

1. Assay device, comprising
an upper casing element (1) having an upper testing compartment inner surface (1a) and a first opening (3);
a stack of functional layers, comprising an upper membrane layer (6) and a lower absorbent layer (7) being arranged on top of each other; and
a filter layer (5), which is attached to the upper casing element (1) and extends across the first opening (3); wherein
the filter layer (5) is movable with respect to the stack of functional layers, thereby defining at least a first configuration and a second configuration of the assay device;
wherein the first configuration is characterized by:
the stack of functional layers extending along the upper testing compartment surface (1a), wherein the upper membrane layer (6) of the stack of functional layers is facing the upper testing compartment surface (1a), the filter layer (5); and the first opening (3) of the upper casing element (1);
wherein the second configuration differs from the first by removing the filter layer (3) from the upper casing element.

A second, more particular embodiment refers to a further developed variant of the above general embodiment, which still makes use of the basic principles of said general embodiment:

2. Assay device, comprising
an upper casing element (1) and a lower casing element (2),
the upper (1) and the lower casing element (2) being assembled in such a manner that a testing compartment is formed, which is suited to take up a stack of functional layers (5, 6, 7),
the testing compartment comprising an upper testing compartment inner surface (1a) of the upper casing element (1) and a lower testing compartment inner surface (2a) of the lower casing element (2),
the upper casing element (1) being movable with respect to the lower casing element (2), thereby defining a first configuration and a second configuration of the assay device,
the upper casing element (1) having a first opening (3) and a second opening (4), which both provide access from the outside to the testing compartment,
the first opening (3) and the second opening (4) being arranged in such a manner that the position of the first opening (3) with respect to the lower casing element (2) at the first configuration is essentially the same as the position of the second opening (4) with respect to the lower casing element (2) at the second configuration.

3. Assay device according to embodiment 2,
characterized in that
the upper casing element (1) is rotatable with respect to the lower casing element (2).

4. Assay device according to one of the preceding embodiments,
characterized in that
the stack of functional layers comprises an upper membrane layer (6) and a lower absorbent layer (7), which are arranged on top of each other and extend essentially in parallel to the upper testing compartment surface (1a) and the lower testing compartment surface (2a).

5. Assay device according to one of the preceding embodiments,
characterized in that
at least the upper membrane layer (6) is fixed to the lower casing element (2).

6. Assay device according to embodiment 5,
characterized in that
at least one cut-out (6a, 6b, 7a, 7b) is formed in the upper membrane layer (6), and
at least one protrusion (8a, 9a) is formed on the lower testing compartment surface (2a) in such a manner that the cut-out (6a, 5b, 7a, 7b) engages with the protrusion (8a, 9a) in order to secure a position of the upper membrane layer (6) relative to the lower testing compartment surface (2a).

7. Assay device according to one of the preceding embodiments,
characterized in that
the testing compartment is provided with a filter layer (5), which is arranged essentially in parallel to the upper membrane layer (6), wherein
the filter layer (5) is arranged in such a manner that it is positioned between the first opening (3) and the upper membrane layer (6) and
the filter layer (5) is attached to the upper testing compartment surface (1a).

8. Assay device according to embodiment 7,
characterized in that
the filter layer (5) comprises a grid.

9. Assay device according to one of the preceding embodiments,
characterized in that
   the upper membrane layer (6) is spaced apart from the upper testing compartment inner surface (1a).

10. Assay device according to one of the preceding embodiments,
characterized in that
a movement limiter (21) is formed in the upper casing element (1) and another movement limiter (22) is formed in the lower casing element (2), wherein
the movement limiters (21, 22) are provided in such a manner that the upper casing element (1) is movable with respect to the lower casing element (2) between a first extreme position corresponding to the first configuration and a second extreme position corresponding to the second configuration.

11. Assay device according to one of the preceding embodiments,
characterized in that
the upper (1) and the lower casing element (2) are assembled by interlocking with each other.

12. Assay device according to one of the preceding embodiments,
characterized in that
a label (11) is arranged on the upper casing element (1) on a surface opposite to the upper testing compartment surface (1a).

13. Assay device according to one of the preceding embodiments,
characterized in that
the assay device further comprises a card (10), which is provided with a hole (10a), wherein the upper (1) or lower casing element (2) engages with the hole (11a).

14. Assay device according to embodiment 13,
characterized in that
a recession (8b, 9b) is formed in the lower casing element (2) and the hole (10a) of the card (10) is provided with a notch in such a manner that the recession (8b, 9b) engages with the hole, thereby securing a position of the lower casing element (2) relative to the card (10).

15. Assay device according to one of the preceding embodiments,
characterized in that
the upper casing element (1) has several first openings (3) and second openings (4), every one of the first openings (3) being associated with one second opening (4), wherein
the first openings (3) and the second openings (4) are arranged in such a manner that the positions of the first openings (3) with respect to the lower casing element (2) at the first configuration are essentially the same as the position of the associated second openings (4) with respect to the lower casing element (2) at the second configuration.

16. A method, in particular diagnostic or analytical method, for assessing blood or blood constituents, in particular blood cells, which method comprises applying a device as defined in anyone of the preceding embodiments.

17. The method of embodiment 16, for assessing in a liquid whole blood sample or a sample derived therefrom one or more subclasses of blood cells of interest (BCol), each of which carrying a first distinguishable cell surface marker (M1) for said sub-class of blood cells of interest,

wherein said sample may additionally comprise disturbing blood cells (DBC), which carry at least one of said first cell surface markers (M1) as non-specific marker, and/or at least one free non-cell surface bound form of any of said first cell surface markers (M1) which method comprises
(1) removing from said sample any disturbing blood cells (DBC) via the upper functional layer (5, 106) of the device,
(2) removing from said sample as obtained in step (1) any free, non-cell surface bound form of each of said first cell surface markers (M1) via the functional layer (6,104) of said device; and
(3) assessing in the sample as obtained in step (2) each of said sub-classes of BCol, carrying said first cell surface marker (M1), which are retained on the functional layer (6, 104).

18. The assay method of embodiment 17, which is a vertical flow assay method.

19. The assay method of one of the embodiments 17 and 18, wherein in step (1) said DBCs are removed by filtration through the filter layer (5, 106).

20. The assay method of embodiment 19, wherein said DBCs are aggregated, which aggregates are retained by the filter applied in step (1).

21. The method of embodiment 20, wherein said DBCs are aggregated by means of immunoglobulin molecules which do not bind said BCol.

22. The method of embodiment 21, wherein said DBCs are aggregated by means of immunoglobulin molecules which bind to a second (distinguishable) cell surface marker (M2) which is not present on the surface of said BCol, in particular, wherein said second cell surface marker (M2) may be specific for said DBCs.

23. The method of embodiment 22 or 23, wherein said DBC binding immunoglobulins are selected from free antibodies, polymeric antibodies or antibodies bound to the surface of solid particles, in particular polymer particles.

24. The method of one of the preceding embodiments 17to 23, wherein in step (2) said non-cell surface bound form of said first cell surface marker (M1) is removed by filtration by applying a filter (6, 104) which is permeable for said non-cell surface bound form of said first cell surface marker (M1) but which retains said BCol.

25. The method of one of the embodiments 17 to 24, wherein said assessment of step (3) is performed by means of immunoglobulin molecules reactive with said first cell surface marker (M1).

26. The method of embodiment 25, wherein said immunoglobulin molecules are labelled.

27. The method of embodiment 26, wherein said label is selected from an enzyme, a fluorescent or colored molecular marker or a fluorescent or colored particle.

28. The method of one of the preceding embodiments 17 to 27, wherein said BCol are selected from a sub-class of lymphocytes, in particular T-lymphocytes, and said DBCs are monocytes.

29. The method of one of the preceding embodiments 17 to 28, wherein said first cell surface marker (M1) is a T-lymphocyte marker (M1a), in particular the CD4 cell surface receptor molecule.

30. The method of one of the preceding embodiments 17 to 29, wherein said one or more sub-classes of blood cells of interest (BCol) to be assessed comprises CD4⁺ cells.

31. The method of one of the preceding embodiments 17 to 30, where said first cell surface marker (M1a) is CD4 and said first sub-class of cells is T-helper cells.

32. The method of one of the preceding embodiments 17 to 31, where said method also comprises the assessment of a second sub-class of BCol carrying a distinguishable cell surface marker (M1b) different from said first cell surface marker (M1a).

33. The method of embodiment 32, wherein said cell surface marker (M1b) is a T-lymphocyte marker different from M1a, in particular the surface marker CD8 and said second sub-class of BCol comprises CD8⁺ cells.

34. The method of embodiment 33, where said surface marker (M1b) is CD8 and said second sub-class of cells is cytotoxic T-cells.

35. The method of one of the embodiments 32 to 34, wherein the assessment of said second sub-class of BCol carrying said second cell surface marker (M1b) is performed in step (3) together with the assessment of said first subclass of BCol, carrying a first cell surface marker (M1a), in particular in the same sample.

36. The method of one of the embodiments 32 to 34, wherein the assessment of said second sub-class of BCol carrying said marker (M1b) is performed separately.

37. Thee method of embodiment 36,

which method comprises
(4) optionally removing from said sample any disturbing macromolecular impurities which might disturb the assessment via the upper functional layer (5, 106) of the device
(5) removing from said sample (optionally as obtained in step (4)) any free, non-cell surface bound form of said second cell surface markers (M1b) via the functional layer (6, 104) of the device; and
(6) assessing in the sample as obtained in step (5) said sub-class of BCol carrying said cell surface marker (M1b), which are retained on the functional layer (6, 104).

38. The method of embodiment 37, wherein in step (5) said non-cell surface bound form of said first cell surface marker (M1b) is removed by filtration by applying a filter (6, 104) which is permeable for said non-cell surface bound form of said cell surface marker (M1b) but which retains said sub-class of BCol carrying (M1b).

39. The method of embodiment 38, wherein said assessment of step (6) is performed by means of immunoglobulin molecules reactive with said cell surface marker (M1b).

40. The method of embodiment 39, wherein said immunoglobulin molecules are labelled.

41. The method of embodiment 40, wherein said label is selected from an enzyme, a fluorescent or colored molecular marker or a fluorescent or colored particle.

42. The method of one of the preceding embodiments 17 to 41, wherein said DBCs are CD14⁺ monocytes.

43. The method one of the preceding embodiments 17 to 42, where the aggregation of DBCs in step (1) is performed by adding a first liquid comprising immunoglobulins, said liquid being able to lyse erythrocytes contained in the sample.

44. The method one of the preceding embodiments 17 to 43, comprising the steps of

(1a) mixing the said sample or an aliquot of the said sample with a first liquid comprising antibodies binding to other structures on the surface of other cells different from said specific sub-group of cells but carrying said CD4 receptors, forming particles or aggregates or clusters of particles or cells with a size significantly larger than the size of the cells in said specific sub-group of cells,

(1b) filter away said formed particles or aggregates or cluster of particles or cells by means of a first filter (5, 106) that is constituted by a size exclusion filter, and

(2) passing the remaining mixture through a second filter (6, 104) retaining the said specific sub-group of cells (in said sample but letting CD4 receptor molecules in solution pass through the filter, optionally followed by a washing step,

(3a) followed by exposing the said second filter (6, 104) to a liquid comprising labeled antibodies specifically reactive to said CD4 receptors, where said label is constituted by an enzyme or colored or fluorescent particle, optionally followed by a washing step,

(3b) optionally followed by adding a substrate to said enzyme generating a colored or fluorescent substance, and

(3c) measuring the intensity of the color or the fluorescence on said second filter (6, 104) and correlating said intensity to the concentration of said class of CD4 receptors on the surface of the said specific sub-group of cells

45. The method of one of the preceding embodiments 17 to 44, wherein a (selective) hypotonic lysis of erythrocytes is performed to said blood sample prior to the assessment ( i.e. before step (1), (1a) and (4) is performed).

46. The method of one of the preceding embodiments 17 to 45, wherein the cell count for the group of CD4⁺ cells is assessed.

47. The method of embodiment 46, wherein the cell count for the group of CD4⁺ cells, and at least for one further group of cells, different from CD4⁺ cells, in particular for the group of CD8⁺, cells is assessed, in particular the CD4/CD8 ratio.

48. A method for assessing the quantity of CD4 receptors located on the surfaces of CD4⁺ cells and optionally for assessing the quantity of CD8 receptors located on the surfaces of CD8⁺ cells in a sample of whole blood or a sample derived from blood, which method comprises performing a method of one of the embodiments 17 to 47 and correlating the signal obtained for the assessment of the group of CD4⁺ cells with the quantity of cell-bound CD4⁺ receptor, and optionally correlating the signal obtained for the assessment of the group of CD8⁺ cells with the quantity of cell-bound CD8⁺ receptor.

49. The method of one of the preceding embodiments 17 to 48, wherein said immunoglobulin molecules as applied in said method are antibodies, like monoclonal or polyclonal non-human, in particular non-rodent antibodies, like avian antibodies.

50. The method of one of the preceding embodiments 17 to 49, wherein the immunoglobulins applied for binding to (M1a) and/or (M1b) (in particular CD4⁺ and/or CD8⁺ cells) are covalently bound to coloured latex particles having a mean particle diameter in the range of 30 to 500 nm.

### c) Further Embodiments

Further variants of the above embodiments will be described below:

As stated above, a general embodiment of the assay device, comprises an upper casing element having an inner surface and an opening; a stack of functional layers, comprising an upper membrane layer and a lower absorbent layer being arranged on top of each other; and a filter layer, which is attached to the upper casing element and extends across the first opening (for addition of sample, washing solutions and reagent solution); wherein said filter layer is movable with respect to the stack of functional layers.

In particular said general embodiment refers to a vertical flow assay device which comprises an upper cover sheet (i.e. said upper casing element) provided with at least one circular liquid sample feed opening (i.e. said first opening) and a lower absorbent layer fixed to said upper cover sheet; a first circular filter (i.e. said filter layer) being removably inserted into said at least one circular opening; a second filter (i.e. said upper membrane layer) being fixed between said upper cover sheet and said lower absorbent layer, and separating said at least one feed opening and the circular filter inserted therein from said lower absorbent layer.

In particular, in said upper layer in the form of a square disc, a central circular aperture (for addition of sample, washing solutions and reagent solution) may be provided. Underneath the said square disc on its lower surface, a thin layer of glue is provided in order to fix a circular piece of a filter (or membrane layer) with a suitable pore size to the lower side of said disc layer, with its center in the middle of the central aperture of said square disc. The glue layer also fixes to the lower side of the said square disc a square absorbent pad of about the same size as that of the upper disc. In the central hole of said square disc, on top of the underlying filter, a disc of a suitable net filter, attached to a carrier ring is inserted into the central aperture and is removably fastened to the upper side of said square disc by means of an adhesive tape fixed to the upper side of said ring. In said tape a central aperture is formed which allows adding the sample to be analyzed, and washing reagents on top of the net filter. Said filter may be removed from the device after sample addition and washing is completed by pulling off the tape. Washing buffer and further reagents may then be added to the remaining “opened” device through said aperture directly onto the second filter (or membrane layer). The test result (as for example a color reaction, may be visually inspected and further analyzed through said aperture (2). The lower side of the absorbent layer and optionally its outer edges may additionally be covered with a tightening or blocking layer, for example a polymer layer, which secures that assay or sample liquid absorbed by the absorbent layer is retained within said absorbent.

As stated above, the more advanced assay device according to the invention comprises a two-part casing formed by an upper casing element and a lower casing element. The casing elements may be made of different materials conventionally used in the manufacture of medical single-use assay devices; particularly polymer materials may be used, as for example homo- or copolymer based duro- or thermoplastic material. Non limiting examples are polyesters, polystyrene, polyacrylates, polyalkylenes and polyalkanoates and should be inert, so that they do not disturb the assay. The upper and the lower casing element are assembled in such a manner that a testing compartment is formed, which is suited to take up a stack of functional layers. The testing compartment comprises an upper testing compartment inner surface of the upper casing element and a lower testing compartment inner surface of the lower casing element. Particularly, the testing compartment is defined by the upper and lower casing element as an inner testing compartment which is thus protected from the environment and accessible only via a limited number of openings formed in the upper casing element.

The upper casing element is movable, as for example rotatable, with respect to the lower casing element, thereby defining at least a first configuration and a second configuration of the assay device. Particularly, the upper casing element is thus movable, as for example rotatable, relative to the stack of functional layers.

The upper casing element has a first opening and a second opening, which both provide access from the outside to the testing compartment. Particularly, this allows access from the outside to the stack of functional layers. The first opening and the second opening are arranged in such a manner that the position of the first opening with respect to the lower casing element at the first configuration is essentially the same as the position of the second opening with respect to the lower casing element at the second configuration. Thereby, one defined position of the inside of the testing compartment, in particular a defined segment or section on the upper functional layer (in particular the membrane layer), can advantageously be accessed through the first and the second opening separately in the first and second configuration.

The movement of the upper casing element with respect to the lower casing element further allows the implementation of at least two process steps of a vertical flow assay, wherein the transition from one step to another, e.g., from a sample application and separation step to a read-out step, may be coupled to the movement of the casing elements.

Particularly, the inner surfaces of the testing compartment are arranged in parallel to each other. Thus, the testing compartment has two parallel upper and lower walls.

Specifically, the movement of the first, upper and second, lower casing element with respect to each other is restricted to one degree of freedom, e.g., translation into one direction or, preferably, rotation around an axis. A translational motion may be implemented, e.g., by supporting the upper casing element on the lower casing element such that a sliding motion of the two with respect to each other is allowed. Particularly, the upper and lower inner testing compartment inner surfaces are arranged in parallel to each other and remain parallel in both the first and second configuration.

In a preferred embodiment of the invention, the upper casing element is rotatable with respect to the lower casing element. Preferably, the rotational movement is carried out around an axis that is running through the center of the testing compartment. Thus, the first configuration may be defined by a first rotation angle of the upper casing element with respect to the lower casing element and the second configuration is defined by a second rotation angle of the upper casing element with respect to the lower casing element.

This allows an advantageously easy usage of the assay device according to the invention. The first and second configuration of the assay device can thus be defined by two rotational angles of the upper casing element relative to the lower casing element. Particularly, the upper and lower casing element are movable between the first and second configuration only along one rotational degree of freedom. Advantageously, the upper and lower testing compartment inner surfaces are arranged in parallel to each other and remain parallel under rotation about the rotational axis.

In another embodiment of the assay device, the stack of functional layers comprises an upper membrane layer which gets into contact with the sample to be analyzed (in particular that fraction of the sample which is not retained by any filter layer provided immediately below the sample feed opening) and a lower absorbent layer (which absorbs those parts of the sample which are not retained by the membrane layer), which layers are arranged on top of each other and extend essentially in parallel to the upper testing compartment inner surface and the lower testing compartment inner surface. Particularly, the upper membrane layer is facing the upper testing compartment inner surface (and thus the openings provided in the upper casing element) and the lower absorbent layer is facing the lower testing compartment inner surface.

Thereby, layer materials required for performing a vertical flow assay can advantageously be provided. Specifically, the upper membrane layer may be interposed between the upper testing compartment inner surface and the lower absorbent layer. Furthermore, the upper membrane layer and the lower absorbent layer may be arranged in the testing compartment such that the first and second opening of the upper casing element are positioned in line with them. Upon addition of a liquid sample or liquid reagent into said first or second openings a vertical flow of the liquid phases from the top to the bottom of the device is observed.

Specifically, the upper membrane layer preferably comprises an (active) semipermeable membrane which does not retain non-agglutinated blood cells (to be assessed via a cell-surface marker protein) and which is also permeable for proteins, polypeptides and low molecular weight constituents of the liquid phase added thereon. Membranes with suitable cut-off values (as for example 10, 20, 50 kDa) are commercially available, The cut-off is determined by the pore size of said filter membranes. A cut-off corresponding to a mean pore size of 3, 5 or 8 μm, is particularly suited, as thereby cellular material is retained while soluble protein fragments cell surface marker proteins, which otherwise would disturb the assay, are absorbed by the absorbent layer below said membrane. For example, nitrocellulose membranes are particularly suited. The lower absorbent layer can comprise an absorbent material, as for example cotton wool. It can thus be used to create a suction force for a sample that is introduced into the assay device, and take up excess fluid.

In another embodiment, the upper membrane layer is fixed to the lower casing element. Thus, the upper membrane layer is provided in such a manner that its position with respect to the lower casing element is equal in the first and second configuration. Particularly, a movement of the upper casing element relative to the lower casing element corresponds to a movement relative the upper membrane layer.

Also, the lower absorbent layer may be fixed to the lower casing element. Thus, the respective positions of the materials inside the testing compartment are easily defined, particularly relative to the lower casing element.

Preferably, upper membrane layer and the absorbent layer in a vertical projection are of identical shape and size and thus substantially superimposable. Said shape and size are adapted to the size and shape of the testing compartment wherein said layers are inserted in said compartment in form-locking (or positive-locking) manner.

Alternatively merely the shape and size of the adsorbent layer is adapted to the size and shape of the testing compartment wherein said layer is inserted in said compartment in form-locking (or positive-locking) manner. The size of the upper membrane layer, which in that case should be firmly attached to the absorbent layer, is smaller than the size of the absorbent layer, and corresponds essentially in its shape and size to the shape and size of said first (and second) opening. In any case the upper membrane layers shape should be in the form of a round disc with a surface sufficiently large to quantitatively retain on top of the layer the cell material to be analyzed.

Specifically, both the upper membrane layer and the lower absorbent layer are arranged in a fixed position relative to the lower casing element and the upper casing element is movable with respect to an ensemble of the lower casing element, and the stack of functional layers, e.g., the upper membrane layer and the lower absorbent layer. Thus, the movement of the upper casing element with respect to the lower casing element advantageously translates to a change of the position of the first and second opening of the upper casing element with respect to the upper membrane layer and the lower absorbent layer.

In another embodiment, at least one cut-out is formed in the upper membrane layer. Also, several cut-outs may be formed. At least one protrusion is formed on the lower testing compartment inner surface in such a manner that the cut-out engages with the protrusion in order to secure a position of the upper membrane layer relative to the lower testing compartment inner surface.

Preferably, the at least one or several cut-outs are also formed in the lower absorbent layer.

Also, the at least one cut-out of the lower absorbent layer can engage with the protrusion.

This allows advantageously restricting the movement of the upper membrane layer, and preferably the lower absorbent layer, with respect to the lower casing element in a very easy way. Specifically, the secured position relative to the lower testing compartment inner surface is the same for the first and second configuration of the assay device.

Alternatively or additionally, other attachment means may be used for the same purpose. For example, the upper membrane layer and/or the lower absorbent layer may be glued to the lower testing compartment inner surface and/or to each other. Also, a spike may be provided in the testing compartment, preferably on the lower testing compartment inner surface, and the upper membrane layer and/or the lower absorbent layer may be held by the spike.

In another embodiment, the testing compartment is provided with a filter layer, which is arranged essentially in parallel to the upper membrane layer. Herein, the filter layer is arranged in such a manner that it is positioned between the first opening and the upper membrane layer. The filter layer can, e.g., be inserted into the first opening. Particularly, it may be provided in any way that allows it to extend over the first opening. Thereby the filter layer forms a semipermeable barrier between the sample addition site and the membrane layer, and this quantitatively retains cell agglutinates optionally contained in the sample to be analyzed. Said filter layer may be made from different material. Preferably it is made of organic inert polymer material which does not disturb the assay. For example the filter may be a Nylon net filter, having a grid size in the range of 18 to 50 pm, preferably 22 to 40 μm, more preferably 25 to 33 μm.

Particularly, the filter layer extends over a section of the upper membrane layer such that access to the upper membrane layer through the filter layer is restricted, e.g., for particles above a certain size. Thus, the first opening can advantageously be used to perform a filtering step of the assay that is to be performed by the assay device. For example, the first opening may be provided as a sample feeding opening, wherein a sample is fed into the testing compartment through the filter layer, where it is filtered, e.g., to remove particles above a certain size.

Furthermore, the filter layer is attached to the upper testing compartment inner surface. The attachment may be achieved by different attachment means, e.g., the filter layer may be glued to the upper testing compartment inner surface. Alternatively or additionally, the upper testing compartment inner surface can have a recession and the filter layer may be arranged at least partially, preferably completely, in said recession, thus restricting it from moving. Furthermore, a spike may be provided on the upper testing compartment inner surface and the filter layer may be held by the spike.

The filter layer may be attached, for example by means of glue, to the upper testing compartment inner surface such that its movement is restricted with respect to the upper casing element. Specifically, the position of the filter layer with relative to the upper casing element is the same in the first and the second configuration of the assay device. Particularly, the position of the filter layer relative to the stack of functional materials in the testing compartment is changed by moving the upper casing element.

Preferably, the filter layer does not extend over or overlap with the second opening, i.e., the filter layer is smaller than the upper membrane layer. Thus, the second opening may be provided as a reading opening for an optical inspection of the testing compartment from the outside. Specifically, the second opening can allow an optical inspection of the side of the upper membrane layer that is facing the upper testing compartment inner surface. Furthermore, the optical inspection of the upper membrane layer through the first opening may be obstructed by the filter layer and/or filtered material of the sample.

Particularly, the first opening and the filter layer extend over a limited section of the upper membrane layer in the first configuration, such that access to the upper membrane layer from the outside is mediated through the filter layer. In the second configuration, the second opening extends over said section, while the filter layer (and the first opening) is position above a different section of the upper membrane. Thus, access to the upper membrane layer may be unrestricted by the filter layer, e.g., allowing an optical connection to the upper membrane layer from the outside.

In another embodiment, the filter layer comprises a grid. The grid can, e.g., comprise a nylon grid. Thus, a filter step can advantageously be implemented in order to prevent particles or cells, or preferably cell agglomerates, artificially formed by crosslinking of certain blood cells by means of antibody binding, of a given minimum size from reaching the testing compartment and specifically the upper membrane layer. Particularly, agglutinated cellular blood components can thus be filtered away and prevented from reaching lower membrane materials of the vertical flow assay.

In another embodiment, the upper membrane layer is spaced apart from the upper testing compartment inner surface. The spacing may preferably be in the range of 0.1 and 0.25 mm. Thus, frictional forces and particularly smearing effects can advantageously be avoided when the upper casing element is moved relative to the lower casing element, particularly when the stack of functional layers in the testing compartment is fixed to the lower casing element.

In other, less preferred, embodiments, the upper membrane layer may also be in contact with the upper testing compartment inner surface, directly or indirectly through another layer.

In another embodiment, a movement limiter is formed in the upper casing element and another movement limiter is formed at the lower casing element, wherein the movement limiters are provided in such a manner that the upper casing element is movable with respect to the lower casing element between a first extreme position corresponding to the first configuration and a second extreme position corresponding to the second configuration. Thus, the movement may be advantageously limited such that the user can easily switch from the first to the second configuration of the assay device. The movement limiters may be formed in different ways.

If the upper and lower casing element are movable with a rotational degree of freedom, a first and a second extreme rotational angle may be defined.

If the upper and lower casing element are movable with a translational degree of freedom, a first and second translational extreme position may be defined.

In the case of a rotational movement, a first and a second extreme rotation angle may be defined by the positions of the movement limiters. Thus, the upper casing element may be rotated with respect to the lower casing element such that the position of the sample feed opening with respect to the lower casing element at the first extreme angle is essentially the same as the position of the inspection opening with respect to the lower casing element at the second extreme angle.

The upper or lower casing element may be provided with a grip ridge in order to facilitate moving the upper casing element with respect to the lower casing element. Thus the operation of the assay device, specifically the switching between the first and the second configuration, is facilitated. The ridge can particularly be suited to operation by hand and/or with fingers of the user's hand.

In another embodiment, the upper and lower casing element are assembled by interlocking with each other. The interlocking assembly is provided in a well-known way. For example, latches may be provided in order to fix the assembly of upper and lower casing element. Particularly, the movement of the upper casing element with respect to the lower casing element may be restricted to one degree of freedom by a suited interlocking mechanism.

In another embodiment, a label is arranged on the upper casing element on a surface opposite to the upper testing compartment inner surface. The label may be provided with holes corresponding to the first and second opening of the upper casing element. Thus, evaluating the readout of the assay device is advantageously facilitated.

Specifically, an explanatory imprint comprising, e.g., a color and/or intensity index may be given for assigning a quantitative value to an optical readout of the vertical flow assay. Alternatively or additionally, further information may be given on the label such as about how to perform the assay. The label may be oriented and positioned fixed with respect to the upper casing element. Also, the label may be oriented such that it is visible to a user together with the second opening of the upper casing element.

In another embodiment, the assay device further comprises a card, as for example of the standardized size of a bank or credit card, which is provided with a hole, wherein the upper or lower casing element engages with the hole. This allows advantageously providing a larger area surrounding the assay device. The area of the card may be used for printing information for a user, e.g., an explanatory imprint comprising instructions for the use of the assay device, conducting an analytical assay and/or evaluating a result.

In another embodiment, a recession is formed in the lower casing element and the hole of the card is provided with a notch in such a manner that the recession engages with the hole, thereby securing a position of the lower casing element relative to the card. Particularly, the recession engaging with the notch fixes the card with respect to the lower casing element and prevents it from rotation. Alternatively, the position of the upper casing element may be defined relative to the card.

Thus, the upper or lower casing element is advantageously fixed with respect to the card. This may facilitate the use and integration of the assay device into an analytical workflow. Also, other attachment means may be used to keep the casing element at the defined position relative to the card, such as glue or welding.

In another embodiment, the upper casing element has several, preferably pairwise arranged first openings and second openings, as for example 4, 3, or preferably 2 pairs, every one of the first openings being associated with one second opening. Thus, pairs of first and second openings are provided. Herein, the first openings and the second openings of each pair are arranged in such a manner that the positions of the first openings with respect to the lower casing element at the first configuration are essentially the same as the position of the associated second openings with respect to the lower casing element at the second configuration. Thus, the arrangement of first and second openings corresponds for each pair to the arrangement of only one first and second opening.

Thus, it is advantageously possible to carry out more than one analysis of the same or different analytes(like cell surface markers, like CD4 and CD8 cell surface markers) at a time with one-device, thereby reducing time, cost and consumption of materials. Specifically, the same type of measurement may be carried out for different blood samples on a single assay device according to the invention, or the same sample may be subjected to different tests, e.g., analyses for different receptors. Particularly, different positions on one analytical membrane may be used to test several samples. Also, different analytical functions may be implemented in one assay device.

The method according to the invention for assessing blood cells in general terms is the following:

An assay method for assessing in a liquid whole blood sample or a sample derived therefrom, one or more sub-classes of blood cells of interest (BCol), each sub-class carrying a first distinguishable cell surface marker (or cell surface receptor molecule) (M1) for said sub-class of blood cells of interest, which means that the markers (M1) for different sub-classes of cells are different (i.e. antigenically different and therefore distinguishable) from each other, wherein said sample may additionally comprise (or is suspected to comprise) disturbing blood cells (DBC), which carry at least one of said first cell surface markers (M1) as non-specific marker, and/or wherein said sample may additionally comprise (or is suspected to comprise) at least one free (dissolved), non-cell surface bound form, like a (soluble) extracellular fragment, of at least one, preferably of each of said first cell surface markers (M1), which method comprises
(1) removing from said sample any disturbing blood cells (DBC), which also carry at least one of said first cell surface markers (M1);
(2) removing from said sample as obtained in step (1) any free, non-cell surface bound form of each of said first cell surface markers (M1); and
(3) assessing in the sample as obtained in step (2) each of said sub-classes of BCol, carrying said first cell surface marker (M1).

In the above steps (1), (2) and (3) a device according to the present invention is applied as explained in more detail in above section “b) Particular preferred embodiments”.

In particular, said whole blood sample is blood from a mammalian, preferably human, individual, like a blood donor, or a patient suffering from a disease or suspected to suffer from a disease affecting the cellular profile or composition of the population of whole blood cells, in particular of at least one of said BCol. It can be obtained e.g. from venous collection through a needle, or from capillary blood collected after a finger stick by a sharp object.

In a first particular alternative the present method comprises the assessment of one single sub-class of BCol, and steps (1) to (3) are performed once. Preferably, said one single sub-class comprises CD4⁺ cells, and the surface marker M1 is CD4. The DBC comprise CD14⁺ cells which also carry the M1 marker CD4, in particular said DBC comprise CD14⁺ monocytes. Said non-cell surface bound form of said first cell surface marker M1 is derived from CD4, i.e. comprises a soluble fragment thereof.

In a second particular alternative the present method comprises the assessment of two different sub-classes of BCol and steps (1) to (3) are performed separately for each subclass of cells.

In a variant of said second particular alternative the present method comprises the assessment of two different sub-classes of BCol (as for example CD4+ cells and CD8+ cells) and steps (1) to (3) are performed for a first subclass of BCol (as for example CD4+ cells) and at least steps (2) and (3) are separately performed for the second sub-class of cells (as for example CD8+ cells) if no other blood cells would disturb the assessment of said second sub-class of cells.

Preferably, said two different sub-classes comprises CD4⁺ cells (the first sub-class) and CD8⁺ cells (the second subclass) and the surface markers M1 to be assessed are CD4 (i.e. M1a) and CD8 (i.e. M1b). The DBC comprise CD14⁺ cells, in particular CD14⁺ monocytes, which also carry said CD4 marker (M1a). Said non-cell surface bound form of said markers M1a and M1b is derived from CD4 and/or CD8, i.e. comprises a soluble, non-cell bound fragment of CD4 and/or CD8.

In a third particular alternative the present method comprises the assessment of two different sub-classes of BCol and steps (1) to (3) are performed only once.

In a fourth particular alternative the present method comprises the assessment of two different subclasses of BCol and steps (1) and (2) are performed only once while step (3) is performed for each of said subclasses separately.

Preferably in said above second, third and fourth alternatives, said two different sub-classes comprises CD4⁺ cells (the first sub-class) and CD8⁺ cells (the second subclass) and the surface markers M1 to be assessed are CD4 (i.e. M1a) and CD8 (i.e. M1b). The DBC comprise CD14⁺ cells, in particular CD14⁺ monocytes, which also carry said CD4 marker (M1a). Said non-cell surface bound form of said markers M1a and M1b is derived from CD4 and/or CD8, i.e. comprises a soluble fragment of CD4 and/or CD8.

Further variants of said method are described above

In particular, a detectable signal in said reading openings is generated according to the invention, for example by applying an antibody coupled to a colored or florescent marker, as for example a colored polymer particle. The correlation between color or fluorescence generated in a method of the present invention in each reading opening of the device and the concentration of the particular class receptor molecules to be analyzed (as for example CD4 and /or CD8 receptors), can be performed as follows: There is a direct relationship between the amount of the said specific receptor molecules and the color to be measured, since the amount of colored particles or fluorescent molecules bound relates to the amount of said specific receptor molecules present in the sample to be tested. This color is then detectable either visually with comparison to pre-evaluated, pre-calibrated and/or predetermined coloristic diagrams or by measurement of the amount of color by electronic color detectors either freely available on the marked or the one developed for the present invention. Measurement instruments used are easily calibrated and adjusted to colored substances or immunoparticles used, their color scheme and detection range needed. In calibration for detection instruments a known amount of analyte is used, giving a good ratio of background vs. signal, and will allow users to be provided with exact calculated readouts. If an enzyme—including but not limited to peroxidase enzymes or alkaline phosphatase—is used in the place of colored or fluorescent substances, a color generating or a fluorescent generating substrate for said enzymes are used. Measurements of two components with different color deposited on a filter by measurement of reflectance at two and more wavelengths is well known to the skilled man of the art. It was already described in Clinical Chemistry 43:12 2390-2396 (1997) in the article “Glycohemoglobin filter assay for doctors' offices based on boronic acid affinity principle” by Frank Frantzen et al., in U.S. 5,702,952 by Erling Sundrehagen and Frank Frantzen, and in U.S. 5,506,144 by Sundrehagen and Frantzen. Frantzen et al used a specialized reflectometer measuring reflectance (% R) at 620 and 470 nm. Measurements at these wavelengths were used to quantitate the blue-colored boronic acid conjugate and red hemoglobin (Hb), respectively. The instrument automatically performed Kubelka-Munk transformations (Kubelka P. New contributions to the optics of intensely light scattering materials. J Opt Soc Am 1948; 38:448-57) to linearize the recorded reflectance data. A “Portable rapid diagnostic test reader” is described in EP 2 812 675 and a “Spectroscopic sensor on mobile phone” is described in US 2006/0279732. Today the camera function on the mobile phone is commonly used for reflectometric measurements of filter based test devices in diagnostic medicine.

Such systems are also described in EP 0 953 149 (B1) by Sundrehagen and Bremnes. Many companies today deliver reflectometric scanning instruments or digital camera imaging software for measuring intensity and wavelength of reflected light from test spots on diagnostic devices, comprising software for calibration for computing the concentration on samples from intensity and wavelength of reflected light. The Scansmart system from Skannex AS, Oslo, Norway, is an example of an automated and dedicated system for this application. Also standard “smartphones” with digital cameras can be used to obtain digital images of the color signal obtained. Typically, the digital images are then uploaded into Adobe Photoshop electronic program. This method allows graphic presentation of the results. This method also allows the determination of when the signal is strongest versus when the background is lowest. Standardization and calibration of the signals can be obtained by using reference spots with known intensity and concentration of the analyte to be measured.

If enzymatic color system generation is used, then kinetic measurements can be employed, and the measurement can be performed using a “video” mode.

The software Adobe Photoshop Elements 13© and the program “Eyedropper tool” may be used to determine HSL and Red, Green and Blue and other color schemes to determine color of uploaded images. The HSL (hue, saturation and lightness) scheme provides a device-independent way to describe color. Especially instructive is http://www.handprint.com/LS/CVS/color.html on the internet (July 2015).

In a special embodiment of the present invention, reference colored spots are placed or fastened in close proximity to the membrane with immobilized antibodies or other binding molecules or fragments thereof, preferentially on the holder of the assay membrane (as for example on the upper side of the upper casing element or, if applicable, on the card, holding the assay device, as described above as well as in the following sections). As a part of the measurements of the assay of the present inventions, these reference spots are measured as well. The measurement of said reference spot can, by the software of the measurement instrument, be used to compensate for instrument-to-instrument and other hardware variations, to increase the overall accuracy of the assay.

These reference spots may define a color scale for each color in the analytical measurement. The instrument, e.g., the camera on a mobile telephone, takes a picture or a series of pictures of the surface to be measured, and also the reference spots on the device. Different software programs can convert the pixels measured into numeric values and define color rooms in different numeric system. Very common is the RGB (Red Green Blue) color space. The RGB color model is an additive color model in which red, green, and blue light are added together in various ways to reproduce a broad array of colors. The name of the model comes from the initials of the three additive primary colors, red, green, and blue. (Wikipedia 16 July 2016) HSL and HSV are the two most common cylindrical-coordinate representations of points in an RGB color model. The two representations rearrange the geometry of RGB in an attempt to be more intuitive and perceptually relevant than the cartesian (cube) representation. Developed in the 1970s for computer graphics applications, HSL and HSV are used today in color pickers, in image editing software, and less commonly in image analysis and computer vision.

A very modern and free software package in use today to measure and analyze color spots and give them numerical values in a color room, is GIMP. GIMP/gimp/(GNU Image Manipulation Program) is a free and open-source raster graphics editor used for image retouching and editing, free-form drawing, resizing, cropping, photo-montages, converting between different image formats, and more specialized tasks. See www.gimp.org, where all aspects are explained.

The invention is now described referring to the figures.

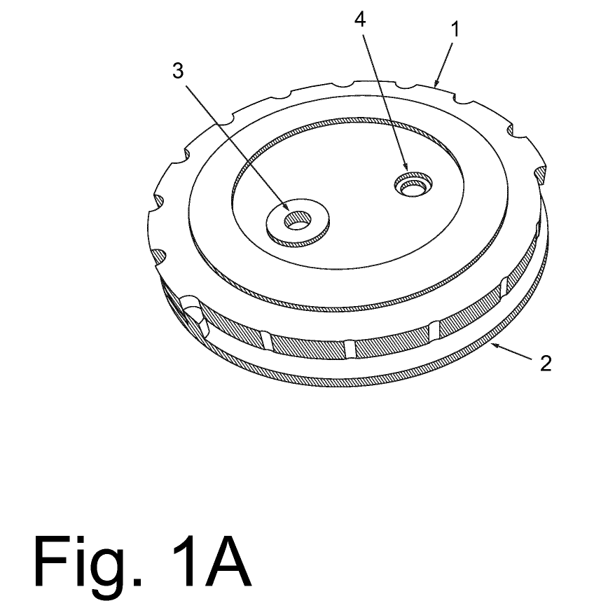

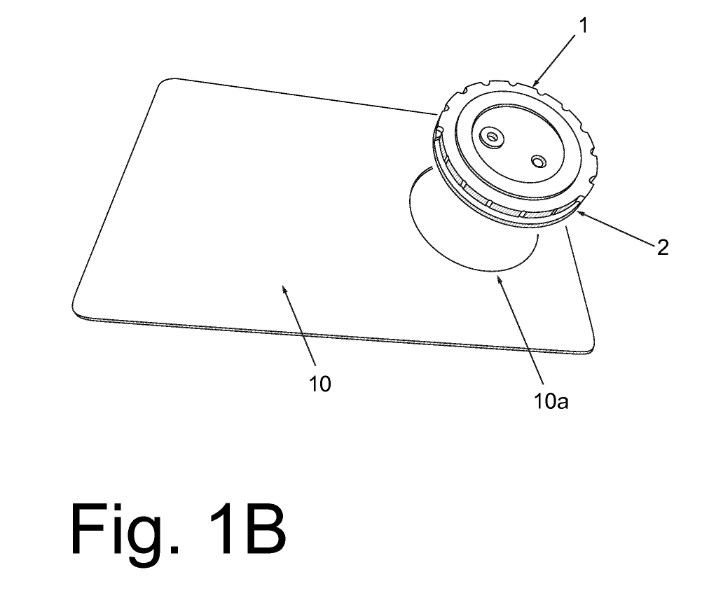

FIGS. 1A and 1B show a first embodiment of the assay device according to the invention,

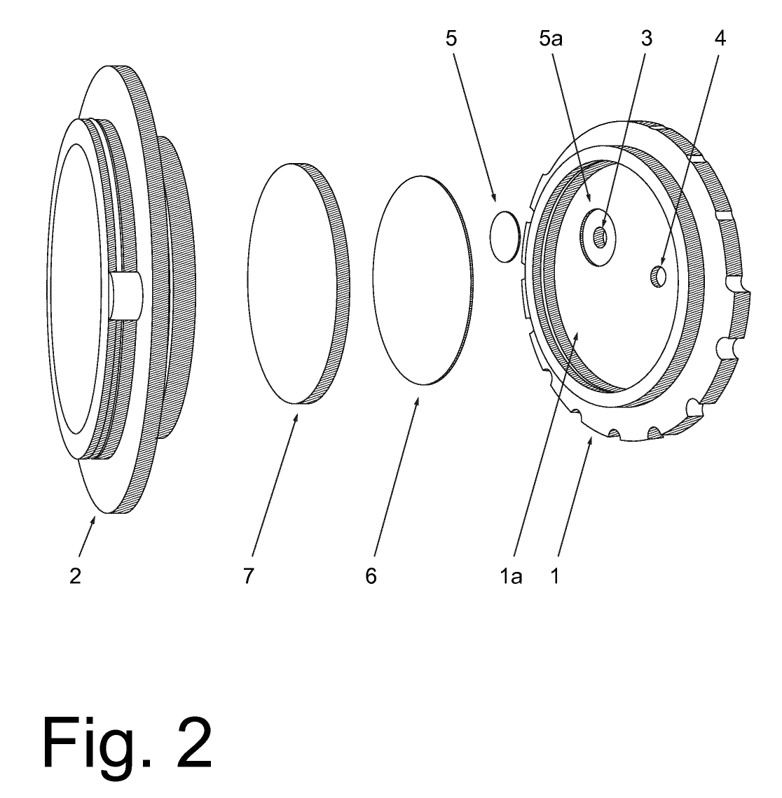

FIG. 2 shows an exploded view of the first embodiment of the assay device according to the invention,

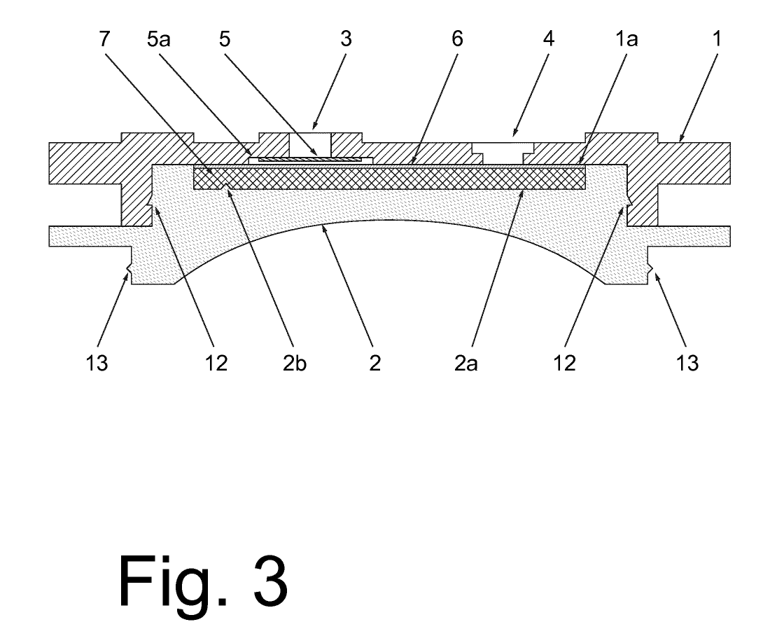

FIG. 3 shows a cross section of the first embodiment of the assay device according to the invention,

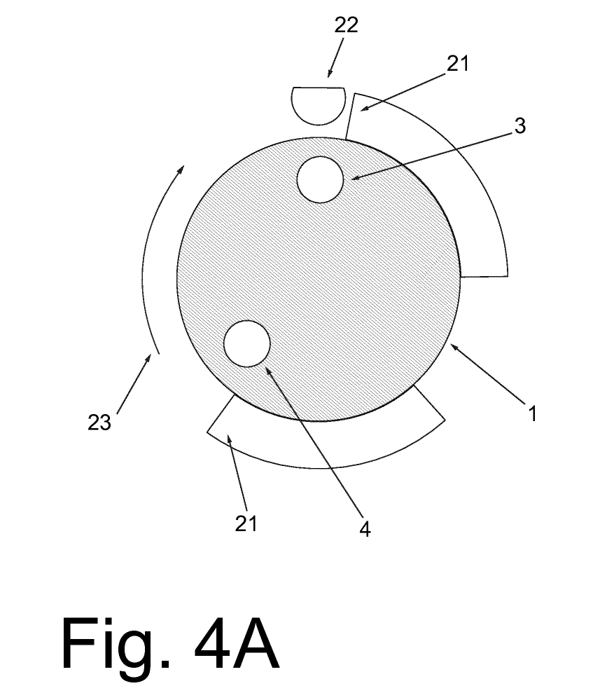

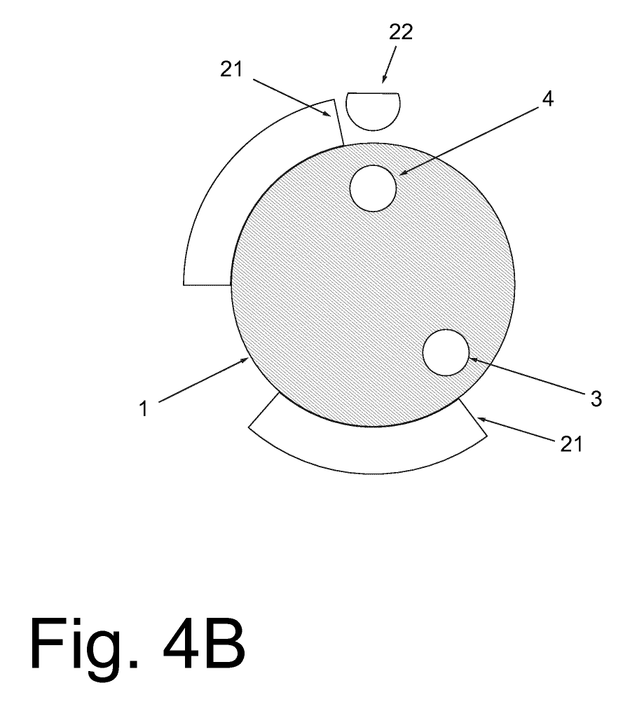

FIGS. 4A and 4B show the operation of the first embodiment of the assay device according to the invention,

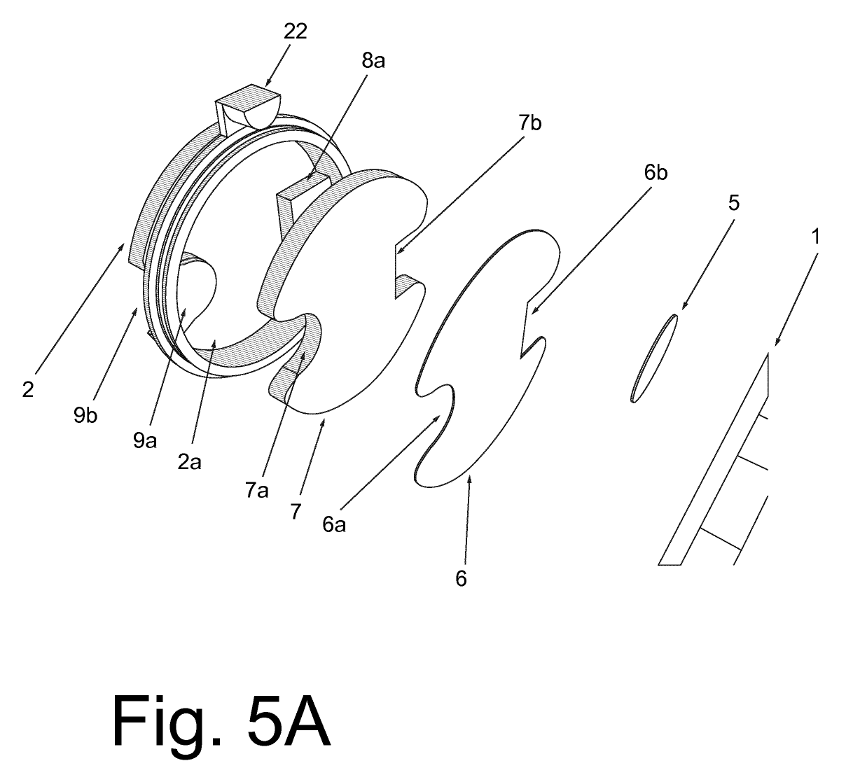

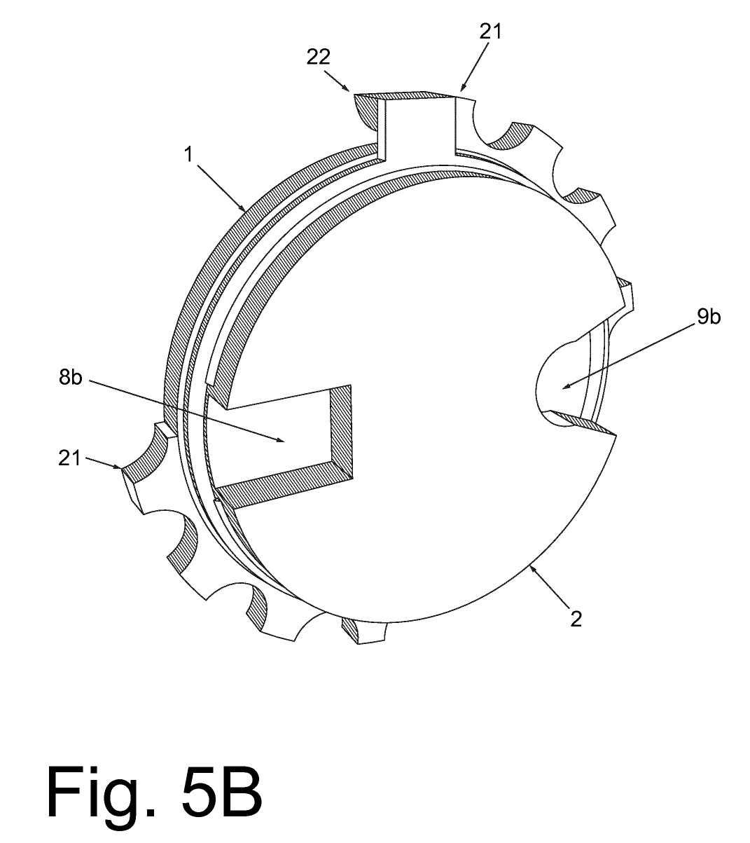

FIG. 5A shows an exploded view of a second embodiment of the assay device according to the invention,

FIG. 5B shows the second embodiment of the assay device according to the invention,

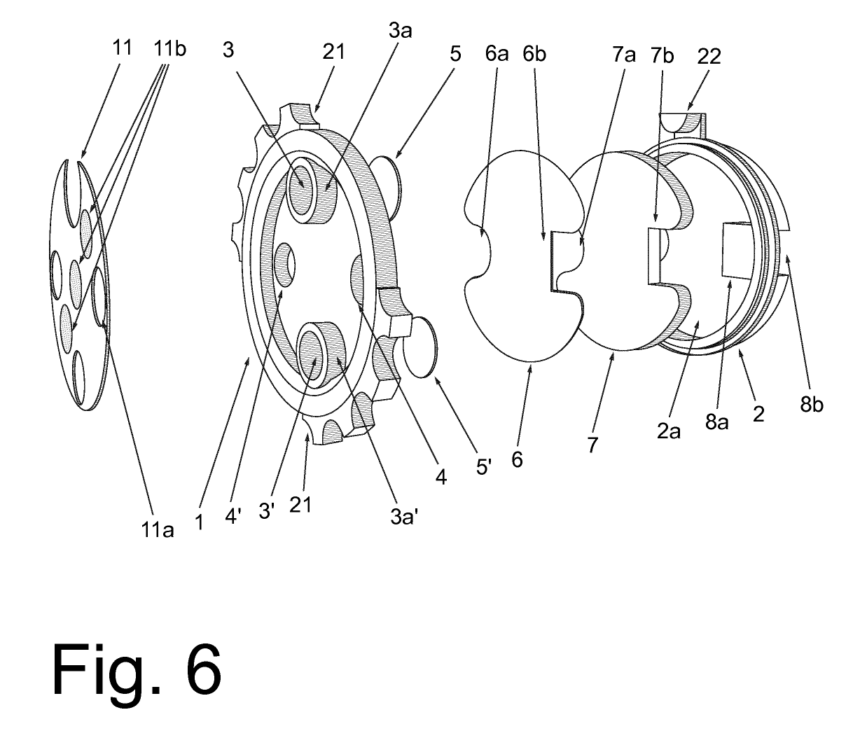

FIG. 6 shows an exploded view of a third embodiment of the assay device according to the invention,

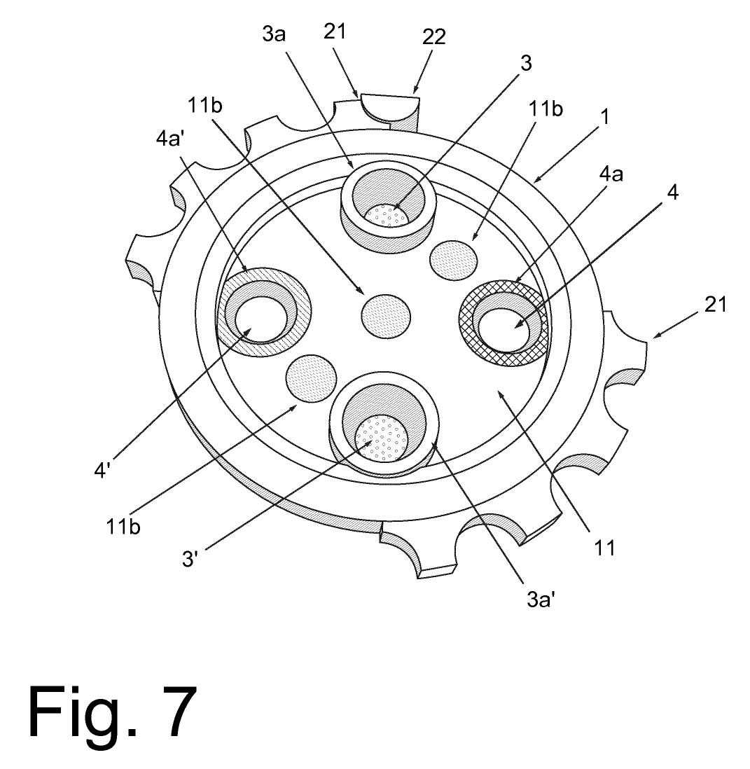

FIG. 7 shows a top view of the third embodiment of the assay device according FIG. 6, and

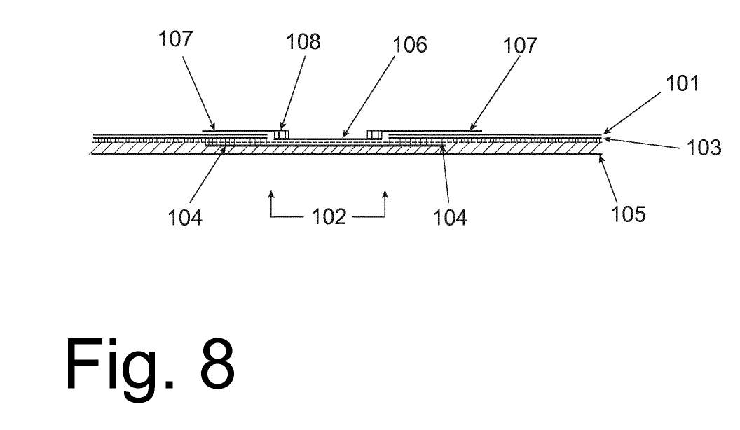

FIG. 8 shows a sectional view of an assay device according to a general embodiment of the invention.

With reference to FIGS. 1A and 1B, a first embodiment of the assay device according to the invention is described.

The assay device comprises an upper casing element 1 and a lower casing element 2. The upper casing element 1 has a first opening 3, in the depicted case a sample feed opening, and a second opening 4, in the depicted case a reading opening 4. The upper 1 and the lower casing element 2 are assembled on top of each other. The assembly comprising the upper 1 and lower casing element 2 has the shape of a flat round disc, i.e. the radius of the resulting assembly is larger than the thickness of the disc.

In an optional variant of this embodiment, a card 10 is provided with a hole 10a, which is suited to take up the assembled assay device. Particularly, the shape of the hole 10a of the card 10 is formed in such a way that it is suited to interlock with at least one portion of the lower casing element 2. The hole 10a may also comprise a notch, which is suited to hold the lower casing element 2 in place and to prevent it from a rotation with respect to the card 10.

In another variant of this embodiments, an explanatory imprint may be provided on the card 10, e.g., instructions for the use of the assay device or information to facilitate the quantification of measurements using the assay device, as for example reference colored spots as explained above.

With reference to FIGS. 2 and 3, an exploded view and a cross-section of the first embodiment of the assay device according to the invention is described.

The upper 1 and lower casing element 2 comprise an upper 1a and a lower testing compartment inner surface 2a, which are facing each other and extend essentially in parallel to each other. The upper 1 and lower casing element 2 are furthermore formed in such a way that a testing compartment is formed between them. The upper 1a and lower testing compartment inner surface 2a form the top and bottom surfaces of a cylindrical testing compartment.

The testing compartment is provided with an upper membrane layer 6 and a lower absorbent layer 7, which are arranged on top of each other and extend essentially in parallel to the upper 1a and the lower testing compartment inner surface 2a. In this embodiment, the testing compartment is essentially filled out by the upper membrane layer 6 and the lower absorbent layer 7, i.e. said layers as inserted in form-locking manner. In further embodiments, the upper membrane layer 6 is spaced apart from the upper testing compartment inner surface 1a, while still being inserted in the lower testing compartment in form-locking manner.

The second, lower testing chamber inner surface 2a is provided with a protrusion 2b that is suited to hold the lower absorbent layer 7 in place by restricting its mobility, in particular by inhibiting any mobility during the rotational movement of the assay device during the assay procedure, particularly by completely avoiding rotational movement inside the testing compartment. In other embodiments of the invention, the protrusion 2b further extends into the testing compartment and is suited to also hold the upper membrane layer 6 in place. In other embodiments, the lower absorbent layer and/or the upper membrane layer are kept in place alternatively or additionally by other attachment means, e.g., by glue.

The assembly further comprises a filter layer 5, which in the depicted embodiment is arranged inside a recession 5a of the upper testing compartment inner surface 1a right below the first opening 3. The filter layer 5 is attached to the upper casing element 1, particularly to restrict its motion with respect to the upper casing element 1. In the depicted case, the filter 5 is glued to the upper casing element 1 such that the first opening 3 is covered on the side facing the testing compartment.

In this embodiment, the second opening 4 of the upper casing element 1 serves primarily as a reading opening 4, wherein the second opening offers direct optical access from outside through the upper casing element 1 to the testing compartment and an unobstructed view of the upper membrane layer 6. The second opening 4 is also used for the addition of reagent solutions and washing solutions on top of the membrane layer carrying the analyte (like particular blood cells) retained on the surface of said membrane layer 6.

In this embodiment, the lower absorbent layer 7 comprises an absorbent material for taking up lower molecular substances and liquid which are not retained by the upper membrane 6. The upper membrane layer 6 comprises a semi-permeable membrane retaining the analyte, in particular blood cells suspected to carrying the analyte in said cells, or preferably, on the cell surface. Furthermore, the filter layer 5 comprises a semi-permeable membrane, permeable for non-agglutinated blood cells and smaller constituents of the sample, while retaining larger agglomerates of blood cell which have to be removed before the analytical detection reaction on the surface of the upper membrane is finally performed.

The assembly of the upper 1 and lower casing element 2 comprises an interlocking mechanism in which the upper casing element 1 takes up a portion of the lower casing element 2. Due to the round shape of the interlocking portions of the upper 1 and lower casing element 2, the upper 1 and lower casing element 2 may be rotated with respect to each other, wherein a rotational angle defines a position of the two casing elements 1, 2 to each other. Latches 12 are provided on the interlocking portion of the lower casing element 2, which are suited to hold the assembly of the upper 1 and lower casing element 2 firmly in place and leave essentially only a rotational degree of freedom for motion of the casing elements 1, 2 relative to each other.

Furthermore, latches 13 are provided on a portion of the lower casing element 2 interlocking with the hole 10a in the card 10 as shown in FIG. 1b.

The latches 12, 13 may be formed in different ways, as a person skilled in the art will appreciate. Furthermore, corresponding grooves are formed in the upper casing element 1 corresponding to the latches 12 of the lower casing element. Similar structures may be formed in the card 10 in order to facilitate the interlocking action with the lower casing element 2.

With respect to FIGS. 4a and 4b, the operation of the first embodiment of the assay device according to the invention is described.

A simplified top view of the assay device is shown. From this perspective, the first opening 3 and the second opening 4 of the upper casing element 1 are visible as well as the rotation stops 21 provided at the edge of the upper casing element 1. Furthermore, a rotation stop 22 is shown, which is formed in the lower casing element 2 (not shown) in order to restrict the rotational motion of the upper casing element 1 with respect to the lower casing element 2. FIGS. 4A and 4B show two extreme positions, defined by two rotational angles of the upper casing element 1, while the lower casing element 2 is shown static, indicated by the static position of the rotation stop 22. An arrow 23 indicates the direction of the rotation. The two extreme rotational angles indicated here define a first and a second configuration of the assay device. The rotation stops 21 may be formed in different ways as known in the art. In the depicted embodiment, they comprise ridges at the edge of the upper casing element 1.

In the first and second configuration of the assay device, the first opening 3 and the second opening 4, respectively, are shown. The position of the first opening 3 in FIG. 4A is identical to the position of the second opening 4 in FIG. 4B, relative to the rotation stop 22 of the lower casing element 2.

Thus, upon rotation of the upper casing element 1 with respect to the lower casing element 2, the positions of the first opening 3 and the second opening 4 of the upper casing element 1 will change with respect to the lower casing element 2. Therefore, the upper membrane layer 6 and the lower absorbent layer 7, which are assumed to be fixed with respect to the lower casing element 2, may be accessed at the same position through the first 3 and second opening 4 of the upper casing element 1 at the first and second configuration, respectively. In the first configuration, depicted in FIG. 4A, the first opening 3 is shown at a defined position close to the rotation stop 22. At the second configuration, depicted in FIG. 4B, the second opening 4 is shown at the position next to the rotation stop 22, as the first opening 3 before. Thus, after rotating the upper casing element 1 and thus after transitioning from the first to the second configuration, the reading opening 4 has moved to the same position, which was taken by the sample feed opening 3 at the first configuration. Since the filter layer 5 is attached to the upper casing element 1 in the region around the first opening 3 and does not extend to the region of the second opening 4, the filter layer 5 does no longer obstruct the view of the portions below the first opening 3 and a user gets visual access through the second opening 4, which in this embodiment is the reading opening 4. At the same time, sample material as retained by filter grid 5 is removed from the position as defined by opening 3 at the first configuration.

With reference to FIGS. 3, 4a and 4b, the method according to the invention (here for the assessment of CD4 cells) is described below and comprises the following steps:.
1. A whole blood sample was mixed with dilution buffer adapted to hypotonic lysis of erythrocytes as contained in the sample while not lysing the leucocytes. The dilution buffer also contains anti CD14 antibody in a form suitable to agglomerate CD14 monocytes.
2. After a short incubation time an aliquot of said mixture was transferred to the aperture 3 of the device of FIG. 4, and is immediately sucked into the coarse (nylon mesh) filter 5 positioned underneath said aperture 3 and retaining agglutinated CD14 cells while letting pass through CD4+T helper cells which will be retained on the surface of the next filter layer 6.
3. Thereafter, a wash solution was transferred to the aperture 3 of the filtration device and was sucked into the nylon mesh filter 5, and the filter 6.
4. Thereafter, the nylon mesh filter 5 was removed by twisting the upper casing element 1 of the device (angle of rotation more than 90°) so that opening 4 is now exactly in the previous position of opening 3 relative to the filter 5, i.e. the section of the filter where said CD4+helper cells are adsorbed on the filter.
5. Thereafter, a solution of anti-human CD4 receptor antibodies with detectable marker (like enzyme) was transferred to the aperture 4 of the filtration device and was sucked into the filter 6. After the solution was sucked into the filter 6 the antibody-conjugate was allowed to bind to the cells retained on the filter 6.
6. Thereafter, washing solution was transferred to the hole 4 of the filtration device, and was sucked into the filter 6.
7. Thereafter, if an enzyme is used as marker, the corresponding substrate was transferred to the hole 4 of the filtration device and was sucked into the filter 6.
8. A defined time (as for example 5 minutes) thereafter, the color developed was measured, as for example reflectometrically using a SkanSmart CE reader with software delivered by Skannex AS, Norway.
9. The reading was compared to a calibration curve stored in the software generated by calibration samples with known content of T-cell associated CD4 receptor molecules, analyzed in identical experiments, and the content of T-cell associated CD4 receptor molecules was calculated.

If the detectable marker is for example a colored particle, then step 7 and the color development according to step 8 is not of course not necessary.

The CD4 assessment as described above for the more advanced device as depicted in FIGS. 2, 3 and 4, may in analogy also be performed with a device depicted in FIGS. 6 and 7 where two blood samples may be assessed simultaneously and the analyte of said two samples may be identical (as for example CD4 cell surface marker) or different (as for example CD4 and CD8 cell surface marker). The angle of rotation of the upper casing element 1 is in this case in a range of about 90°.

With respect to FIGS. 5A and 5A, a second embodiment of the assay device according to the invention is described.

The general structure of the assay device corresponds to the one described above for the first embodiment. The exploded view shown in FIG. 5A depicts the upper casing element 1 (only partially), the filter layer 5, the upper membrane layer 6, the lower absorbent layer 7 and the lower casing element 2. The lower casing element 2 comprises the lower testing compartment inner surface 2a. From FIG. 5A, the testing compartment may be recognized as having an essentially cylindrical shape.

However, in contrast to the assay device described above, protrusions 8a, 9a are formed on the lower testing compartment inner surface 2a and corresponding cut-outs 7a, 7b, 6a, 6b are formed in the lower absorbent layer 7 and membrane element 6. After the lower absorbent layer 7 and the upper membrane layer 6 have been inserted into the testing compartment above the lower testing compartment inner surface 2a, the cut-outs 7a, 7b, 6a, 6b interlock with the protrusions 8a, 9a, thereby restricting the rotational movement of the lower absorbent layer 7 and the upper membrane layer 6. On the opposite side of the lower casing element 2, recessions 8b, 9b are formed. In this embodiment, the recession 8b, 9b may be used to interlock with latches formed in the hole 10a of the card 10 in order to prevent a rotational movement of the lower casing element 2 with respect to the card 10. Furthermore, rotation stop 22, which is formed as an integral part of the lower casing element 2 is shown in FIGS. 5A and 5B. FIG. 5B depicts a case, when the rotation stop 22 of the lower casing element 2 is in contact with the rotation stop 21 of the upper casing element 1. Furthermore, the skilled person will recognize the possibility of rotating the upper casing element 1 with respect to the lower casing element 2, wherein the rotation is limited to a certain rotational angle by the position of the rotation stops 21 of the upper casing element 1.

With reference to FIG. 6, an exploded view of a third embodiment of the assay device according to the invention is described, characterized by two pairs (3,4 and 3′,4′) of corresponding first and second openings.

The general setup of the assay device is analogous to the structures described above for the first and second embodiment.

The assay device comprises the upper 1 and the lower casing element 2, which may be assembled by interlocking with each other, thereby forming the testing compartment, which is equipped with an upper membrane layer 6 and a lower absorbent layer 7. The upper casing element 1 comprises the upper testing compartment inner surface 1a and the lower casing element 2 comprises the lower testing compartment inner surface 2a. In the lower testing compartment inner surface 2a and protrusions 8a and 9a (not shown) are formed, and corresponding cut-outs 6a, 6b, 7a, 7b are formed in the upper membrane layer 6 and the lower absorbent layer 7 such that a rotational movement of the upper membrane layer 6 and the lower absorbent layer 7 are prohibited.

Furthermore, filter layers 5, and 5′ are attached to the upper casing element 1 in the area of a first openings 3 and 3′ of the upper casing element 1. The upper casing element 1 further comprises second openings 4, 4′. The first openings 3, 3′ further have a ridge 3a, 3a′ around their circumference on the side of the upper casing element 1 opposite to the upper testing compartment inner surface 1a, which is the outer surface relative to the testing compartment. Furthermore, a label 11 is provided on top of the outer side of the upper casing element 1 relative to the testing compartment, wherein the label 11 comprises holes 11a, which are in correspondence with the first 3, 3′ and second openings 4, 4′ of the upper casing element 1. The ridge 3a, 3a′ around one of the openings' 3, 4 circumference is used to ensure a clearly defined arrangement of the label 11 and the upper casing element 1. The label 11 further comprises an explanation imprint 11b, in the depicted case a color scale, which offers information in order to facilitate the conversion of a colorimetric read-out of the assay to a quantitative result.

With reference to FIG. 7, a top view of the third embodiment of the assay device according to the invention is described. The configuration of the assay device is analogous to the structures described above with reference to FIG. 6 for the third embodiment.

For simplification purposes, the lower casing element 2 is not depicted in FIG. 7 except for the rotation stop 22. The upper casing element 1 is provided with two rotation stops 21, which engage with the rotation stop 22 of the lower casing element 2 in the first and second configuration, respectively. Herein, the first configuration of the assay device is shown and the second configuration can be reached by rotating the upper casing element 1 anticlockwise with respect to the lower casing element 2 towards the second extreme rotation angle that is defined by the rotation stops 21, 22.

A first 3, 4 and a second pair 3′, 4′ of first 3, 3′ and second openings 4, 4′ are formed in the upper casing element 1, wherein the first openings 3, 3′ are provided with ridges 3a, 3a′ around their respective circumference. Also, the filter layers 5, 5′ that extend across the first openings 3, 3′ on the bottom side of the upper casing element 1 are shown by a hatching inside the first openings 3, 3′. The pairs of openings 3, 4, 3′, 4′ are arranged in such a manner that, in the second configuration (after rotation), the positions of the second openings 4, 4′ relative to the lower casing element, which is represented by its rotation stop 22, will be essentially the same as the positions of the first openings 3, 3′ in the first configuration.

Furthermore, the label 11 is arranged on the top surface of the upper casing element 1 and the explanation imprint 11b is visible to a user of the assay device. Also, circumferential imprints 4a, 4a′ are provided in the label 11 around the second openings 4, 4′. Different hatching of the circumferential imprints 4a, 4a′ illustrate the differences in coloring that, e.g., help the user to easily differentiate the individual second openings 4, 4′ from each other or give a reference color for the interpretation of a colorimetric read-out of the assay.

With reference to FIG. 8, a sectional view of an assay device according to a general embodiment of the invention is shown. Said vertical section of such a device illustrates in particular the sequence of different layers of filter and adsorbent materials required for performing the assay. In an upper square disc layer 101 a central circular aperture 102 is provided. Underneath the said square disc on its lower surface, a thin layer 103 of glue is provided in order to fix a circular piece of a filter 104 with a suitable pore size, to the lower side of said disc layer 101, with its center in the middle of the central aperture 102 of said disc. The glue layer 103 also fixes to the lower side of the said disc 101 a square absorbent pad 105 of about the same size as that of the disc 101. In the central hole 102 of the disc 101, on top of the underlying filter 104, a disc of a suitable net filter 106, attached to a ring 108 is inserted into the central aperture 102 and is removably fastened to the upper side of disc 101 by means of an adhesive tape 107 fixed to the upper side of the ring 108. In tape 107 a central aperture is formed which allows adding the sample to be analyzed, and washing reagents on top of the net filter 106. Filter 106 may be removed from the device after sample addition and washing is completed by pulling off the tape 107. Washing buffer and further reagents may then be added to the remaining “opened” device through aperture 102 directly onto filter 104. The test result (as for example a color reaction) may be visually inspected and further analyzed through said aperture 102.

References as cited in the above specification are herewith incorporated by reference.

### LIST OF REFERENCE NUMBERS

1 upper casing element
1a upper testing compartment inner surface
2 lower casing element
2a lower testing compartment inner surface
2b protrusion;
3, 3′ first opening; sample feed opening
3a, 3a′ ridge (first opening)
4, 4′ second opening; reading opening
4a, 4a′ circumferential imprint (second opening)
5 filter layer
5a recession (for filter layer)
6 membrane element
6a, 6b cut-out (membrane element)
7 lower absorbent layer
7a, 7b cut-out (lower absorbent layer)
8a, 9a protrusion
8b, 9b recession
9 card
10a hole (card)
11 label
11a holes (label)
11b explanation imprint
12 latch (casing)
13 latch (card)
21 movement limiter; rotation stop (upper casing element)
22 movement limiter; rotation stop (lower casing element)
23 arrow (rotation direction)

1. An assay device, comprising
an upper casing element (1) and a lower casing element (2), the upper (1) and the lower casing element (2) being assembled in such a manner that a testing compartment is formed, which is suited to take up a stack of functional layers (5, 6, 7),
the testing compartment comprising an upper testing compartment inner surface (1a) of the upper casing element (1) and a lower testing compartment inner surface (2a) of the lower casing element (2),
the upper casing element (1) being rotatable with respect to the lower casing element (2), thereby defining a first configuration and a second configuration of the assay device,
the upper casing element (1) having a first opening (3) and a second opening (4), which both provide separately access from the outside to the testing compartment,
the first opening (3) and the second opening (4) being arranged in such a manner that the position of the first opening (3) with respect to the lower casing element (2) at the first configuration is essentially the same as the position of the second opening (4) with respect to the lower casing element (2) at the second configuration, wherein
the assay device is provided with a stack of functional layers, which is taken up by the testing compartment, said stack comprising an upper membrane layer (6) and a lower absorbent layer (7), which are arranged on top of each other and extend essentially in parallel to the upper testing compartment surface (1a) and the lower testing compartment surface (2a), wherein
the testing compartment is provided with a filter layer (5), which is arranged essentially in parallel to the upper membrane layer (6), wherein
the filter layer (5) is arranged in such a manner that it is positioned between the first opening (3) and the upper membrane layer (6) and
the filter layer (5) is attached to the upper testing compartment surface (1a) and does not extend over or overlap with the second opening (4).

2. The assay device according to claim 1,
wherein
at least the upper membrane layer (6) is fixed to the lower casing element (2).

3. The assay device according to claim 3,
wherein
at least one cut-out (6a, 6b, 7a, 7b) is formed in the upper membrane layer (6), and
at least one protrusion (8a, 9a) is formed on the lower testing compartment surface (2a) in such a manner that the cut-out (6a, 5b, 7a, 7b) engages with the protrusion (8a, 9a) in order to secure a position of the upper membrane layer (6) relative to the lower testing compartment surface (2a).

4. The assay device according to claim 1,
wherein
the filter layer (5) comprises a grid.

5. The assay device according to claim 1,
wherein
the upper membrane layer (6) is spaced apart from the upper testing
compartment inner surface (1a).

6. The assay device according to claim 1,
wherein
a movement limiter (21) is formed in the upper casing element (1) and another movement limiter (22) is formed in the lower casing element (2), wherein the movement limiters (21, 22) are provided in such a manner that the upper casing element (1) is movable with respect to the lower casing element (2) between a first extreme position corresponding to the first configuration and a second extreme position corresponding to the second configuration.

7. The assay device according to claim 1,
wherein
the upper (1) and the lower casing element (2) are assembled by interlocking with each other.

8. The assay device according to claim 1,
wherein
a label (11) is arranged on the upper casing element (1) on a surface opposite
to the upper testing compartment surface (1a).

9. Assay The assay device according to claim 1,
wherein
the assay device further comprises a card (10), which is provided with a hole (10a), wherein the upper (1) or lower casing element (2) engages with the hole (11a).

10. The assay device according to claim 10,
wherein
a recession (8b, 9b) is formed in the lower casing element (2) and the hole (10a) of the card (10) is provided with a notch in such a manner that the recession (8b, 9b) engages with the hole, thereby securing a position of the lower casing element (2) relative to the card (10).

11. The assay device according to claim 1,
wherein
the upper casing element (1) has several first openings (3) and second openings (4), every one of the first openings (3) being associated with one second opening (4), wherein
the first openings (3) and the second openings (4) are arranged in such a manner that the positions of the first openings (3) with respect to the lower casing element (2) at the first cponfiguration are essentially the same as the position of the associated second openings (4) with respect to the lower casing element (2) at the second configuration.

12. A method for assessing blood or blood cells, which method comprises applying a device as defined in claim 1.
